(19) United States
(12) Patent Application Publication
(10) Pub. No.: US 2022/0242035 A1
(43) Pub. Date: Aug. 4, 2022

(54) THREE-DIMENSIONAL FORMED OBJECT, METHOD FOR OBTAINING THREE-DIMENSIONAL OBJECT FROM TWO-DIMENSIONAL IMAGE, METHOD FOR MANUFACTURING THREE-DIMENSIONAL PLATE, AND METHOD FOR MANUFACTURING FEMALE MOLD

(71) Applicant: Shuzo SAKATE, Maniwa-shi, Okayama (JP)

(72) Inventor: Shuzo SAKATE, Maniwa-shi, Okayama (JP)

(21) Appl. No.: 17/618,652

(22) PCT Filed: Jul. 3, 2020
(86) PCT No.: PCT/JP2020/026206

§ 371 Date: Dec. 13, 2021

(30) Foreign Application Priority Data
Jul. 3, 2019 (JP) 2019-124456
Aug. 22, 2019 (JP) 2019-152261

(51) Int. Cl. B29C 63/00; B29C 63/22

(52) U.S. Cl. CPC B29C 63/0073; B29C 63/0091; B29L 2031/723; B29C 2793/0027; B29C 63/22

(57) ABSTRACT

Provided is a method of three-dimensionalizing a planar image, including: a shaping step (S1) of shaping a main body (6) three-dimensionally representing a planar image of a form of an object (1) to be shaped; a coating step (S2) of applying a base material to a surface of the main body (6); a digitizing step (S3) of creating image data of the object (1) to be shaped based on the planar image; a sticker creating step (S4) of creating a wrapping sticker (8) having printed thereon the image data of the object (1) to be shaped; and an affixing step (S5) of affixing the wrapping sticker (8) to the surface of the main body (6).

### TECHNICAL FIELD

The present invention relates to a three-dimensional shaped object, a method of three-dimensionalizing a planar image, a method of manufacturing a three-dimensional plate, and a method of manufacturing a female mold.

### BACKGROUND ART

A three-dimensional signboard is a signboard three-dimensionally representing a product or a mascot character of a company. As a known general method for manufacturing the three-dimensional signboard or other three-dimensional shaped objects, the following method of obtaining a three-dimensional shaped object is known. For example, clay or the like is used to create an original mold, and casting of plaster or the like is performed to create a female mold. Then, a resin is injected into the female mold. After the resin is cured, the resin is demolded so that a main body of the three-dimensional shaped object is shaped. Then, the surface of the main body is polished and applied with paint, and the paint is dried. However, this method requires high material cost in the painting step, and also requires a long work time because time for drying and curing the material is long. Accordingly, there is a problem in that the price of the three-dimensional shaped object is inevitably increased. Further, specialized knowledge and sophisticated technology are required in the painting step, and hence there is a problem in that a difference is caused in the quality of the finished three-dimensional shaped object depending on a worker.

As another method, the following method of obtaining a three-dimensional shaped object is known (see, for example, Patent Literature 1). Styrofoam or the like is cut so that the main body of the three-dimensional shaped object is shaped, and the surface of the main body is subjected to coating by applying rigid urethane or the like. After that, the surface of the main body is applied with paint. This method also requires specialized knowledge and sophisticated technology in the painting step, and a difference is caused in the quality of the finished three-dimensional shaped object depending on the worker. Moreover, there is a problem in that the method requires high material cost and long work time.

### CITATION LIST

### Patent Literature

PTL 1: JP 2003-182300 A

### SUMMARY OF INVENTION

### Technical Problem

The present invention has been made to solve the “high price” and the “requirement of highly specialized knowledge and technology,” which have been problems in the related-art shaping method described above, and has an object to provide a technology of three-dimensionalizing an object represented on a photograph or other planar images into a three-dimensional model (three-dimensional shaped object or three-dimensional plate) similar to the actual object, to thereby manufacture the three-dimensional shaped object easily and at low cost.

### Solution to Problem

A first aspect of the present invention relates to a method of three-dimensionalizing a planar image. The method of three-dimensionalizing a planar image according to the present invention includes: a shaping step of shaping a main body three-dimensionally representing a planar image of a form or an object to be shaped; a digitizing step of creating image data of the object to be shaped based on the planar image; a sticker creating step of creating a wrapping sticker having printed thereon the image data of the object to be shaped; and an affixing step of affixing the wrapping sticker to a surface of the main body.

In a preferred aspect of the method of three-dimensionalizing a planar image according to the present invention, the main body is shaped by carving a core material having a thickness.

In the method of three-dimensionalizing a planar image of this aspect, it is preferred that the shaping step include sectionalizing the object to be shaped into a plurality of regions in the planar image, cutting out a plurality of parts from the core material along contours of respective regions of the object to be shaped, and processing each of the plurality of parts so that each part is formed into a predetermined shape, to thereby combine the plurality of parts with each other so that the main body is shaped, it is preferred that the digitizing step include creating the image data for each region of the object to be shaped, it is preferred that the sticker creating step include creating a plurality of wrapping stickers having printed thereon image data pieces of the respective regions of the object to be shaped, and it is preferred that the affixing step include affixing a corresponding wrapping sticker among the plurality of wrapping stickers to a surface of each of the plurality of parts. Further, in the method of three-dimensionalizing a planar image of this aspect, it is preferred that the method further include: a background creating step of providing a surface of the core material with a background after the core material from which the plurality of parts are cut out is processed so as to be thinner than the plurality of parts; and an integrating step of fitting the plurality of parts obtained after the affixing step to the core material obtained after the background creating step, to thereby integrate the plurality of parts with the core material.

In the method of three-dimensionalizing a planar image of this aspect, the shaping step may include cutting out the main body from the core material so as to shape the main body into a predetermined shape, and the method of three-dimensionalizing a planar image may further include: a background creating step of providing a surface of the core material with a background after the core material from which the main body is cut out is processed so as to be thinner than the main body; and an integrating step of fitting the main body obtained after the affixing step to the core material obtained after the background creating step, to thereby integrate the main body with the core material.

Further, in a preferred aspect of the method of three-dimensionalizing a planar image, the shaping step includes sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape, to thereby combine the plurality of parts with each other so that the main body is shaped, the digitizing step includes creating the image data for each region of the object to be shaped, the sticker creating step includes creating a plurality of wrapping stickers having printed thereon image data pieces of respective regions of the object to be shaped, and the affixing step includes affixing a corresponding wrapping sticker among the plurality of wrapping stickers to a surface of each of the plurality of parts.

Further, in a preferred aspect of the method of three-dimensionalizing a planar image according to the present invention, the shaping step includes sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape, to thereby combine the plurality of parts with each other so that the main body is shaped, and the affixing step includes collectively affixing the one wrapping sticker to surfaces of the plurality of parts.

Further, in a preferred aspect of the method of three-dimensionalizing a planar image according to the present invention, the digitizing step includes creating the image data for each region of the object to be shaped sectionalized into a plurality of regions in the planar image, the sticker creating step includes creating a plurality of wrapping stickers having printed thereon image data pieces of respective regions of the object to be shaped, and the affixing step includes individually affixing the plurality of wrapping stickers to surfaces of corresponding regions of the main body.

Further, in a preferred aspect of the method of three-dimensionalizing a planar image according to the present invention, the main body has one or a plurality of air suction holes, and the affixing step includes affixing the wrapping sticker to the main body while sucking air between the main body and the wrapping sticker.

In the method of three-dimensionalizing a planar image according to the present invention described above, in the aspect of creating image data of each region of the object to be shaped in the digitizing step, it is preferred that the image data of each region of the object to be shaped, which is created in the digitizing step, be formed by extending actual image data cut out from entire image data of the object to be shaped along a contour of the each region. In the method of three-dimensionalizing a planar image of this aspect, it is more preferred that the image data of the each region of the object to be shaped include the actual image data of the each region and additional image data added to at least a part around the actual image data.

Further, in a preferred aspect of the method of three-dimensionalizing a planar image according to the present invention, the method further includes: a background creating step of providing a background around a region in which the main body is to be positioned in a surface of a plate material; and an integrating step of mounting the main body obtained after the affixing step on the surface of the plate material obtained after the background creating step so that the main body is positioned in the region, to thereby integrate the main body with the plate material.

A second aspect of the present invention relates to a three-dimensional shaped object obtained by three-dimensionalizing a planar image. The three-dimensional shaped object according to the present invention includes one or a plurality of wrapping stickers having printed thereon image data derived from a planar image of a form of an object to be shaped, the one or plurality of wrapping stickers being affixed to a surface of a main body three-dimensionally representing the planar image.

In a preferred aspect of the three-dimensional shaped object according to the present invention, the plurality of wrapping stickers respectively have image data pieces relating to a plurality of regions of the object to be shaped in the planar image printed thereon, the main body is divided into a plurality of parts so as to correspond to the plurality of regions of the object to be shaped, and the plurality of parts are each processed so as to be formed into a predetermined shape, to thereby combine the plurality of parts with each other so that the main body is formed into a three-dimensional shape, and a corresponding wrapping sticker among the plurality of wrapping stickers is affixed to a surface of each of the plurality of parts. Further, in the three-dimensional shaped object of this aspect, it is preferred that a part of the wrapping sticker affixed to the surface of corresponding one of the parts be sandwiched between the corresponding one of the parts and another part adjacent thereto.

Further, in a preferred aspect of the three-dimensional shaped object according to the present invention, the main body is divided into a plurality of parts so as to correspond to a plurality of regions of the object to be shaped in the planar image, and the plurality of parts are each processed so as to be formed into a predetermined shape, to thereby combine the plurality of parts with each other so that the main body is formed into a three-dimensional shape, and the one wrapping sticker is collectively affixed to surfaces of the plurality of parts.

Further, in a preferred aspect of the three-dimensional shaped object according to the present invention, the plurality of wrapping stickers respectively have image data pieces relating to a plurality of regions of the object to be shaped in the planar image printed thereon, and the plurality of wrapping stickers are individually affixed to surfaces of corresponding regions of the main body.

Further, in a preferred aspect of the three-dimensional shaped object according to the present invention, the one wrapping sticker is affixed to the surface of the main body, and the main body has one or a plurality of holes for sucking air between the main body and the wrapping sticker when the wrapping sticker is affixed to the main body.

Further, in a preferred aspect of the three-dimensional shaped object according to the present invention, the three-dimensional shaped object further includes a plate material provided with a background around a region in which the main body is to be positioned in a surface, and the main body is mounted on the surface of the plate material so that the main body is positioned in the region, to thereby integrate the main body with the plate material.

A third aspect of the present invention relates to a method of manufacturing a three-dimensional plate. The method of manufacturing a three-dimensional plate includes: a shaping step of shaping a main body three-dimensionally representing a planar image of a form of an object to be shaped, the shaping step including sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape, to thereby combine the plurality of parts with each other so that the main body is shaped; a digitizing step of creating image data of the object to be shaped based on the planar image; a step of heat-pressing, with respect to a surface of the main body, a plastic plate having affixed, to a surface thereof, a wrapping sticker having printed thereon the image data of the object to be shaped, or a plastic plate having directly printed, on a surface thereof, the image data of the object to be shaped, while performing vacuuming between the plastic plate and the main body; and a step of removing the main body from the plastic plate.

Further, in a method of manufacturing a three-dimensional plate according to the present invention, the method includes: a shaping step of shaping a main body three-dimensionally representing a planar image of a form of an object to be shaped, the shaping step including sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape; a digitizing step of creating image data of the object to be shaped based on the planar image, the digitizing step including creating the image data for each region of the object, to be shaped; a step of heat-pressing, with respect to surfaces of the plurality of parts, a plurality of plastic plates having individually affixed, to surfaces thereof, a plurality of wrapping stickers having printed thereon image data pieces of respective regions of the object to be shaped, or a plurality of plastic plates having individually and directly printed, on surfaces thereof, the image data pieces of the respective regions of the object to be shaped, while performing vacuuming between the plastic plate corresponding to each part and the each part; a step of removing the plurality of parts from the plurality of plastic plates; and a step of combining and integrating the plurality of plastic plates with each other.

A fourth aspect of the present invention relates to a method of manufacturing a female mold to be used for manufacturing a three-dimensional shaped object obtained by three-dimensionalizing a planar image. The method of manufacturing a female mold according to the present invention includes: a shaping step of carving a core material having a thickness so as to shape a main body three-dimensionally representing a planar image of a form of an object to be shaped; and a step of manufacturing a female mold through use of the main body as an original mold, wherein the shaping step includes sectionalizing the object to be shaped into a plurality of regions in the planar image, cutting out a plurality of parts from the core material along contours of respective regions of the object to be shaped, and processing each of the plurality of parts so that each part is formed into a predetermined shape, to thereby combine the plurality of parts with each other so that the main body is shaped.

### Advantageous Effects of Invention

According to the present invention, the three-dimensional shaped object is formed by three-dimensionalizing an object represented on a photograph or other planar images, and then affixing, to the main body obtained through the three-dimensionalization, a wrapping sticker created based on the planar image. Thus, the three-dimensional shaped object can be manufactured easily and at low cost without requiring highly specialized knowledge or technology. Further, the rough finished look of the finished three-dimensional shaped object can be grasped in advance.

Further, the three-dimensional plate having affixed, to its surface, the wrapping sticker having printed thereon the image data of the object to be shaped, or the three-dimensional plate having printed thereon the image data of the object to be shaped can easily be manufactured. Further, according to the present invention, the female mold to be used for manufacturing the three-dimensional shaped object obtained by three-dimensionalizing the planar image can easily be manufactured, and hence the three-dimensional shaped object can easily be manufactured.

### BRIEF DESCRIPTION OF DRAWINGS

FIG. 1 is a chart for illustrating a flow of steps of a method of three-dimensionalizing a planar image according to an embodiment.

FIG. 2 is a plan view of a line figure created from the planar image.

FIG. 3 is a perspective view for illustrating a state in which a plurality of parts are cut out from a core material.

FIG. 4 is a perspective view for illustrating a state in which the plurality of parts subjected to cutting are combined and integrated with the core material obtained after background creation.

FIG. 5 is a perspective view for illustrating a state after a surface shape of the main body is adjusted.

FIG. 6 is a plan view of image data corresponding to each region of an object to be shaped.

FIG. 7 is a perspective view for illustrating work of affixing corresponding wrapping stickers to the plurality of parts.

FIG. 8 is a perspective view for illustrating a state in which the plurality of parts having the wrapping stickers affixed thereto are combined and integrated with the core material provided with a background.

FIG. 9 is a perspective view of a three-dimensional shaped object.

FIG. 10 is an explanatory table for showing comparison of a simplified process of steps and a work time in each step between the method of three-dimensionalizing a planar image according to the embodiment and a related-art three-dimensional shaping method.

FIG. 11 is an explanatory table for showing a method of three-dimensionalizing a planar image of each of Modification Example 1 to Modification Example 4 in a simplified manner.

FIG. 12 is an explanatory view for illustrating a method of three-dimensionalizing a planar image of each of Modification Example 5 to Modification Example 7 in a simplified manner.

FIG. 13 is a process chart for illustrating a flow of a method of manufacturing a female mold according to an embodiment.

FIG. 14 is a process chart for illustrating a flow of a method of manufacturing a three-dimensional plate according to an embodiment.

FIG. 15 is a process chart for illustrating a flow of a method of manufacturing a three-dimensional plate according to a modification example.

### DESCRIPTION OF EMBODIMENTS

Now, embodiments of the present invention are described with reference to the attached drawings. The present invention relates to a technology of manufacturing, from a planar image representing a form of an object to be shaped, a model (three-dimensional shaped object or three-dimensional plate) similar to the actual object. Examples of the planar image may include a photograph, a painting, a sketch, and an engineering drawing. However, the planar image is not limited thereto as long as the planar image is a two-dimensional representation of the form of the object to be shaped, and various images can be used. Examples of the usage application of the three-dimensional shaped object to be manufactured may include a three-dimensional signboard, a decorative article, and a food model, but the usage application is not limited thereto. Further, examples of the object to be shaped may include artificial objects such as a product and a mascot character, natural objects such as a mountain and a tree, an animal, and food (cooking). However, the object to be shaped is not limited thereto, and may be, for example, letters or symbols.

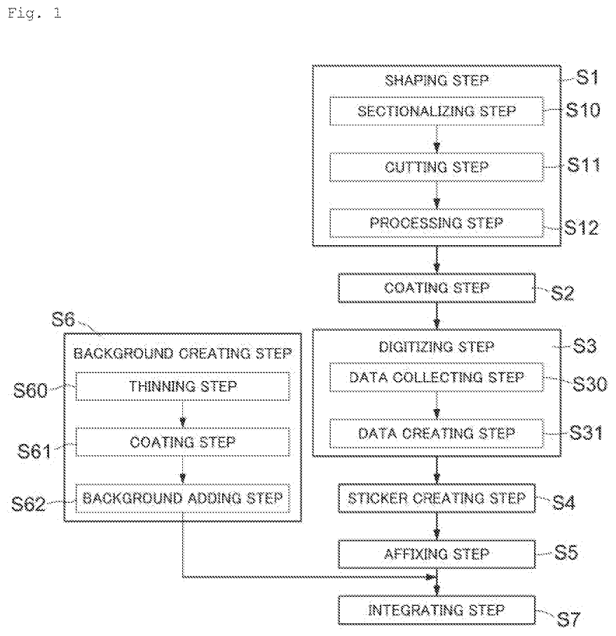

As illustrated in FIG. 1, a method of three-dimensionalizing a planar image according to this embodiment includes a shaping step S1 of shaping a main body three-dimensionally representing a planar image of a form of an object to be shaped, a coating step S2 of applying a base material to a surface of the main body, a digitizing step S3 of creating image data of the object to be shaped based on the planar image, a sticker creating step S4 of creating a wrapping sticker having printed thereon the image data of the object to be shaped, and an affixing step S5 of affixing the wrapping sticker to the surface of the main body obtained after the coating step S2. Now, each step is described in detail.

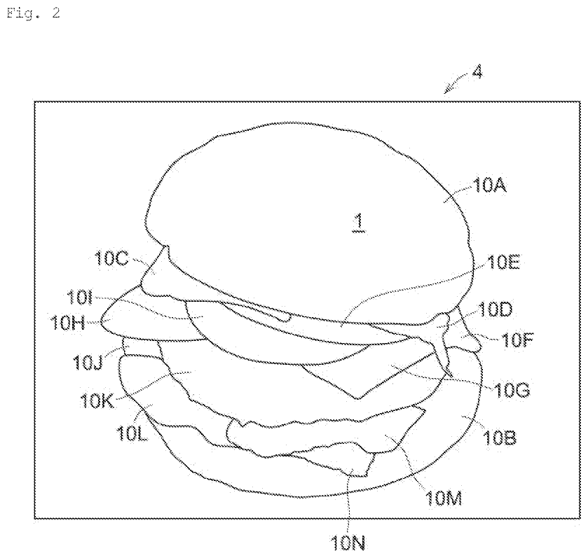

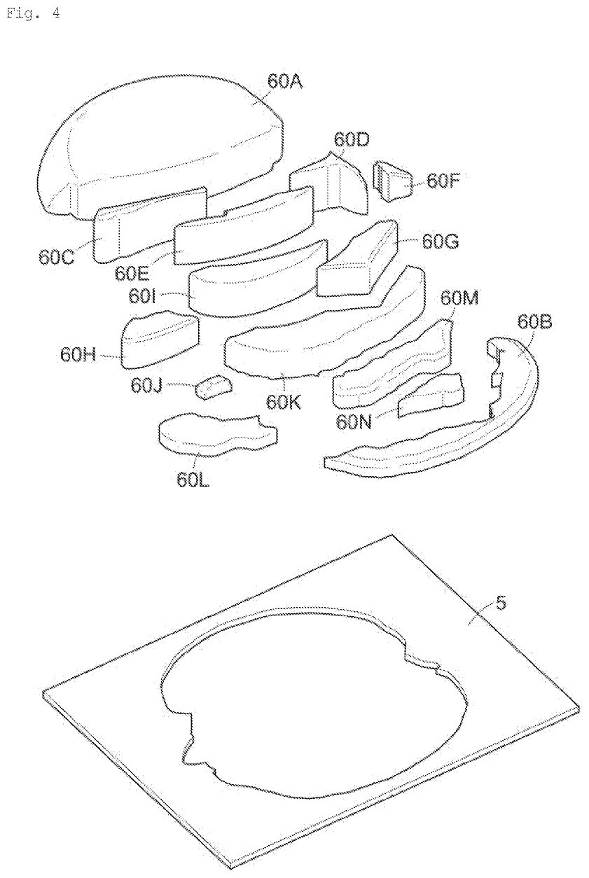

In the shaping step S1, in order to three-dimensionally represent the planar image of the form of the object to be shaped, first, there is performed work (sectionalizing step S10) of sectionalizing the object to be shaped into a plurality of regions in the planar image. Specifically, the planar image is first divided into a part of the object to be shaped to be three-dimensionally represented and a part of a background not to be three-dimensionally represented. Next, for the part of the object to be shaped, a contour of each region forming the object to be shaped is extracted. Then, as illustrated in FIG. 2, there is created a line figure 4 of an object 1 to be shaped representing contours of respective regions 10A to 10N of the object 1 to be shaped with lines. In this embodiment, the object 1 to be shaped is a hamburger, and the object 1 to be shaped is sectionalized into regions 10A to 10N including upper and lower buns 10A and 10B and ingredients 10C to 10N therein.

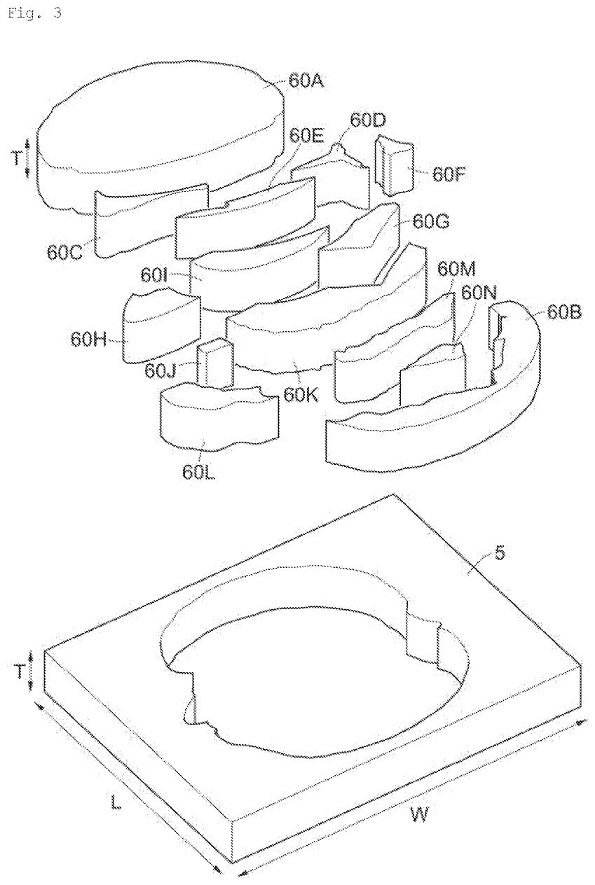

In this embodiment, description is given of an example in which the main body is shaped by carving a core material having a thickness. Accordingly, in the shaping step S1, next, as illustrated in FIG. 3, there is performed work (cutting step S11) of cutting out, from a core material 5, a plurality of parts 60A to 60N along the contours of the respective regions 10A to 10N of the object 1 to be shaped in the planar image. For example, the line figure 4 is fixed onto the core material 5, and the core material 5 is cut along the contours of the respective regions 10A to 10N of the object 1 to be shaped represented on the line figure 4, to thereby cut out the plurality of parts 60A to 60N from the core material 5. The cutting step S11 may be manually performed, or it is also possible to automatically cut out the plurality of parts 60A to 60N from the core material 5 through use of devices such as an automatic cutting machine or a laser processing machine based on the line figure data of the object to be shaped.

In the line figure 4, in FIG. 2, the regions 10A to 10N of the object 1 to be shaped are represented adjacent to each other as in the actual object, but the regions 10A to 10N may be represented in a state with intervals. When a router or the like is used to cut the core material 5 along the contours of the respective regions 10A to 10N of the object 1 to be shaped, because of a thick blade, securing intervals between the regions 10A to 10N allows the core material 5 to be accurately cut so as to cut out the plurality of parts 60A to 60N.

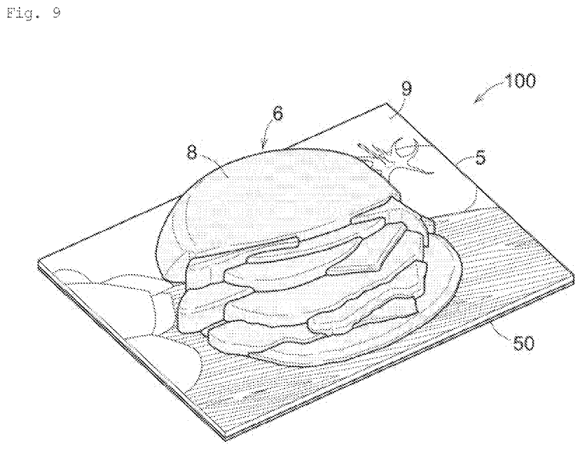

As the core material 5, for example, foam of a synthetic resin such as polystyrene, polypropylene, polyethylene, polyurethane, polyethylene terephthalate, polycarbonate, or the like may be used. When the core material 5 is made of a foamed resin, the weight of the final-form three-dimensional shaped object can be reduced. The material for the core material 5 is riot limited to a foamed resin. For example, wood, synthetic wood such as a wood fiber board (for example, an MDF), or the like may be used, and any material which can be carved or cut may be used. A length L, a width W, and a thickness T of the core material 5 are not particularly limited, and can have various values and are set as appropriate depending on a length, a width, and a maximum thickness (height protruding out from the plane, which is added when a two-dimensional plane is converted into a three-dimensional object) of a final-form three-dimensional shaped object 100 (illustrated in FIG. 9).

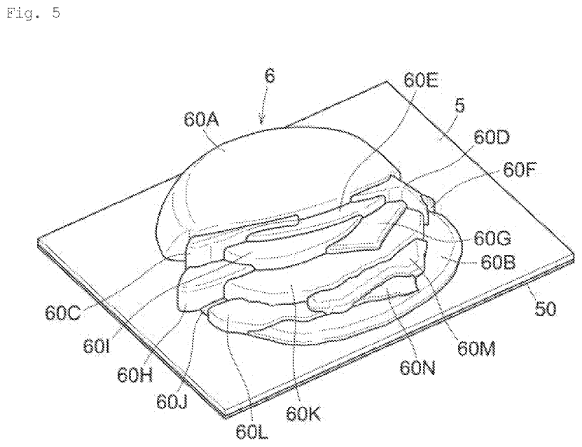

In the shaping step S1, next, there is performed work (processing step S12) of processing each of the plurality of parts 60A to 60N cut out from the core material 5 so that each part is formed into a predetermined shape in accordance with a corresponding region of the object 1 to be shaped. Specifically, for each of the regions 10A to 30N of the object 1 to be shaped in the planar image, it is inferred what shape or dimension each region takes in the final-form three-dimensional shaped object, and as illustrated in FIG. 4, each of the parts 60A to 60N is processed by carving, cutting, or the like so that the shape of each of the corresponding parts 60A to 60N becomes the inferred shape. Then, the plurality of parts 60A to 60N each formed into a predetermined shape in the processing step S12 are combined with each other so that, as illustrated in FIG. 5, a main body 6 three-dimensionally representing the object 1 to be shaped represented on the planar image is shaped.

In the processing step S12, the following work is also performed. Inferring the final-form three-dimensional shaped object, for example, chamfering is performed by rounding off the corners of the respective parts 60A to 60N forming the main body 6, or the surface shape is modified by, for example, shaving and smoothing the surfaces of the respective parts 60A to 60N or forming irregularities thereon. Thus, the appearance of the main body 6 is adjusted so as to come close to the final-form three-dimensional shaped object.

In the coating step S2 after the shaping step S1, although not shown, there is performed work of applying a base material to the surface of the main body 6 so as to protect the surface. With the coating of the base material, a property (for example, strength, durability, or the like) of the surface of the main body 6 can be enhanced, and further the surface of the main body 6 can be smoothened. Further, an adhesive property of a wrapping sticker 8 with respect to the surface of the main body 6 can be enhanced. Examples of the base material may include a water-based urethane resin paint, an epoxy resin paint, and an acrylic resin paint, but the base material is not particularly limited as long as the base material can be used for surface treatment of the main body 6. In this embodiment, the surface of each of the parts 60A to 60N forming the main body 6 is individually coated with the base material.

In the digitizing step S3 after the coating step S2, in order to create wrapping stickers 8A to 8N to be affixed to the surface of the main body 6, which are to be described later, there is performed work of digitizing the planar image so as to create image data of the object to be shaped. In the digitizing step S3, first, there is performed work (data collecting step S30) of importing the planar image as image data. Examples of a method of importing the planar image may include scanning the planar image and picking up an image by a camera, but the method is not particularly limited thereto. The imported image data is stored in a computer having various arithmetic functions. The computer includes, as a hardware configuration, although not shown, a CPU, a memory, an auxiliary storage device (HDD), and the like. The CPU executes various types of arithmetic processing by reading out various programs stored in the HDD to the memory so as to execute the programs. As the computer, for example, a desktop computer, a mobile computer such as a PDA, a multi-function mobile phone (smartphone), or the like may be used. The image data of the planar image can be made clear or modified through use of publicly-known various data correction methods.

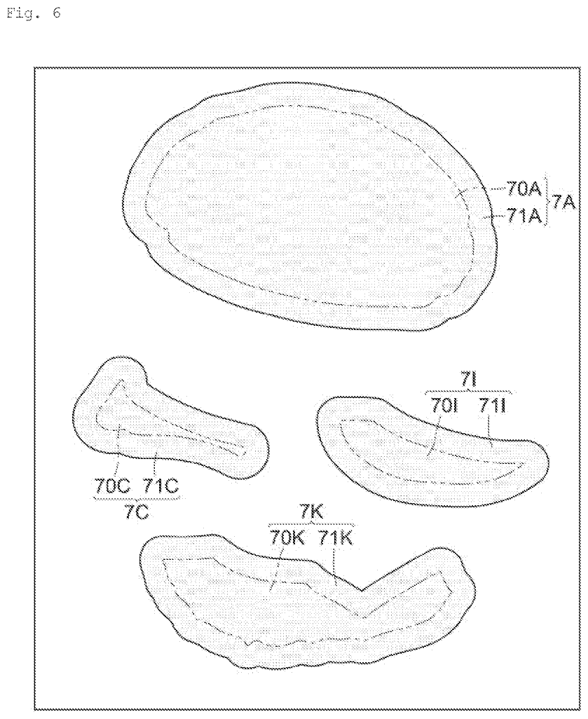

In the digitizing step S3, next, there is performed work (data creating step S31) of creating image data for each region of the object 1 to be shaped based on the imported image data. Specifically, as illustrated in FIG. 6, from the imported image data, image data pieces 7A to 7N corresponding to the respective regions 10A to 10N are created for the respective regions 10A to 10N of the object 1 to be shaped. In FIG. 6, image data pieces 7A, 7C, 7I, and 7K corresponding to the regions 10A, 10C, 10I, and 10K, respectively, are only shown, and image data pieces corresponding to other regions are omitted.

In the data creating step S31, in this embodiment, the image data pieces 7A to 7N corresponding to the respective regions 10A to 10N of the object 1 to be shaped are formed by extending actual image data pieces 70A to 70N cut out from the imported image data along the contours of the regions of the object 1 to be shaped. Specifically, the image data pieces 7A to 7N include the actual image data pieces 70A to 70N, and additional image data pieces 71A to 71N added to at least parts around the actual image data pieces 70A to 70N. The actual image data pieces 70A to 70N match or substantially match the sizes of the upper surfaces among the surfaces of the respective parts 60A to 60N forming the main body 6. Meanwhile, the parts 60A to 60N forming the main body 6 have, in addition to the upper surfaces, side surfaces by the amount of the thickness because the planar image is three-dimensionalised, and it is difficult to cover the side surfaces of the respective parts 60A to 60N only by the actual image data pieces 70A to 70N. Accordingly, in this embodiment, in order to cover not only the upper surfaces but also the side surfaces of the respective parts 60A to 60N, in consideration of the thickness of each of the parts 60A to 60N, the additional image data pieces 71A to 71N created based on the actual image data pieces 70A to 70N are added around the actual image data pieces 70A to 70N for the respective parts. In this manner, the image data pieces 7A to 7N can also cover the side surfaces of the respective parts 60A to 60N for which the image data runs short when a planar image is three-dimensionalized.

As a method of extending the actual image data pieces 70A to 70N to form the image data pieces 7A to 7N, other than the above-mentioned addition of the additional image data pieces 71A and 71N to the actual image data pieces 70A to 70N, the actual image data pieces 70A to 70N may be expanded or parts thereof may be stretched.

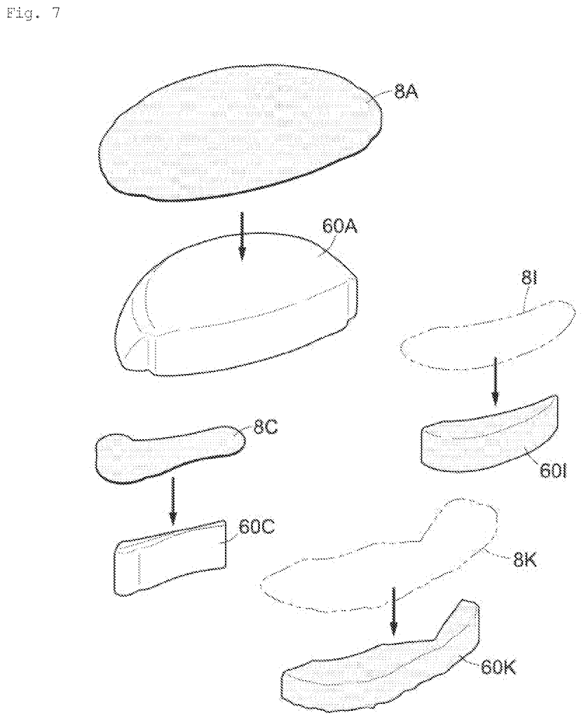

In the sticker creating step S4 after the digitizing step S3, there is performed work of creating, through use of the image data pieces 7A to 7N of the respective regions 10A to 10N of the object 1 to be shaped in the planar image, which are created in the digitizing step S3, a plurality of wrapping stickers 8A to 8N (illustrated in FIG. 7) having the respective image data pieces 7A to 7N printed thereon. The wrapping stickers 8A to 8N may be formed of, for example, paper or a film. A back surface thereof may be applied with a pressure-sensitive adhesive, an adhesive, or the like in advance, or after each of the image data pieces 7A to 7N is printed onto a front surface thereof, the back surface may be applied with a pressure-sensitive adhesive, an adhesive, or the like. A printing method is not particularly limited, and the printing may be performed through use of a publicly-known printing method. In FIG. 1, the wrapping stickers 8A, 8C, 8I, and 8K having printed thereon the image data pieces 7A, 7C, 7I, and 7K, respectively, are only shown, and the wrapping stickers having printed thereon other image data pieces are omitted. Further, in the following description, the plurality of wrapping stickers 8A to 8N are sometimes collectively referred to as “wrapping sticker 8.”

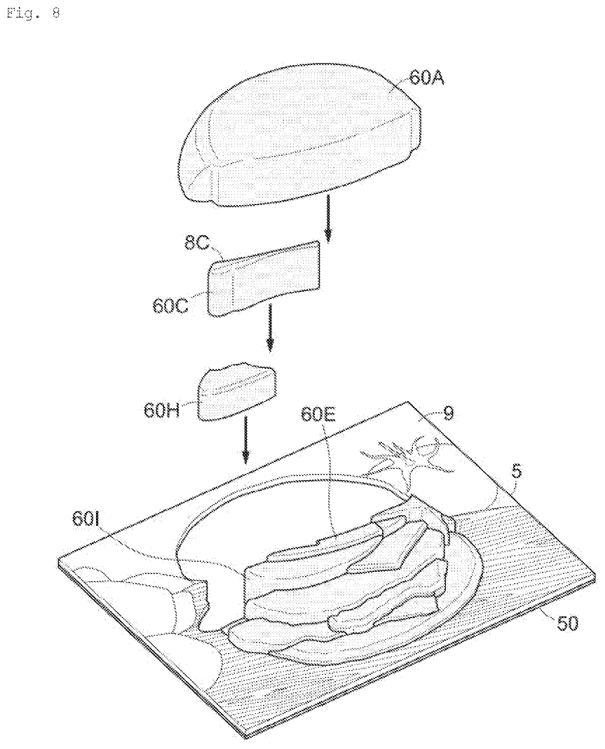

In the affixing step S5 after the sticker creating step S4, there is performed work of affixing the wrapping stickers 8A to 8N to the surface of the main body 6. Specifically, in this embodiment, as illustrated in FIG. 7, a corresponding wrapping sticker among the plurality of wrapping stickers 8A to 8N is affixed to the surface of each of the parts 60A to 60N forming the main body 6. In this embodiment, the wrapping stickers 8A to 8N are affixed to the upper surfaces and the side surfaces of the respective parts 60A to 60N, and hence when the parts 60A to 60N are combined with each other so that the main body 6 is formed as illustrated in FIG. 8, each of the wrapping stickers 8A to 8N (for example, the wrapping sticker 8C) is brought into a state in which a part, thereof is sandwiched between corresponding one of the parts 60A to 60N (for example, the part 60C) to which the corresponding wrapping sticker is affixed and other parts 60A to 60N (for example, the parts 60A, 60E, 60H, and 60I) adjacent to the corresponding part.

The core material 5 (illustrated in FIG. 3) obtained after the plurality of parts 60A to 60N are cut out therefrom in the shaping step S1 is used so as to form the part of the background of the planar image, which is not to be three-dimensionally represented, as described later.

The method of three-dimensionalizing a planar image according to this embodiment further includes, as illustrated in FIG. 1, a thinning step S60 of processing the core material from which the main body (plurality of parts) is cut out, which is obtained after the shaping step S1, so that the core material is thinned, a coating step S61 of applying a base material to a surface of the core material obtained after the thinning step S60, a background adding step S62 of providing the surface of the core material obtained after the coating step S61 with a background, and an integrating step S7 of integrating the main body obtained after the affixing step S5 with the core material obtained after the background adding step S8. The thinning step S60, the coating step S61, and the background adding step S62 correspond to a background creating step S6. Now, each step is described in detail.

First, in the thinning step S60, there is performed work of processing the core material 5 so that the thickness T (illustrated in FIG. 3) becomes smaller than those of the plurality of processed parts 60A to 60N illustrated in FIG. 4. With the thinning step S60, the core material 5 is formed into a thin plate material having a thickness smaller than those of the plurality of parts 60A to 60N as illustrated in FIG. 4. In this manner, when the plurality of parts 60A to 60N are fitted to the core material 5 and integrated with the core material 5, the main body 6 being a three-dimensional object formed by combining the plurality of parts 60A to 60N with each other can protrude out from the core material 5 being a two-dimensional plane serving as the background. In this embodiment, a reinforcing plate 50 is affixed to a back surface of the core material 5, but the reinforcing plate 50 is not always required. Further, a front surface of the core material 5 obtained after the thinning step S60 may be flat or may have irregularities.

In the coating step S61 after the thinning step S60, although not shown, there is performed work of applying a base material to the surface of the core material 5 so as to protect the surface of the core material 5. With the coating of the base material, a property (for example, strength, durability, or the like) of the surface of the core material 5 can be enhanced, and further the surface of the core material 5 can be smoothened. Further, an adhesive property of a wrapping sticker 9 with respect to the surface of the core material 5 can be enhanced. As the base material, for example, the same material as that used in the surface treatment of the main body 6 may be used.

In the background adding step S62 after the coating step S61, there is performed work of providing the surface of the core material 5 with a background. For example, the surface of the core material 5 can be provided with the background as follows. Similarly to the main body 6, from image data created by importing a planar image, image data (background image data) for a part of the background of the planar image is created, and then the wrapping sticker 9 having this background image data printed thereon is created. Then, the wrapping sticker 9 is affixed to the surface of the core material 5. A method of providing the surface of the core material 5 with the background is not particularly limited. For example, a picture may be drawn on the surface of the core material 5 through use of pencils, paints, markers, or the like.

In the integrating step S7 after the background adding step S62, there is performed work of combining and integrating the plurality of parts 60A to 60N obtained after the affixing step S5 with the core material 5 obtained after the background creating step S6. The plurality of parts 60A to 60N are bonded to each other with an adhesive or the like 30 that the main body 6 is assembled, and the main body 6 is bonded to the core material 5 with an adhesive or the like. In this manner, as illustrated in FIG. 9, the three-dimensional shaped object 100 is manufactured. The surface of the three-dimensional shaped object 100 may be subjected to finishing work such as forming fine patterns or giving a luster.

According to this embodiment described above, through use of a photograph or other planar images, for example, a product or a mascot character of a company can be three-dimensionalized at high accuracy and reality. Accordingly, an orderer of the three-dimensional shaped object 100, for example, a three-dimensional signboard can easily order the three-dimensional shaped object 100, and can grasp in advance the rough finished look of the finished three-dimensional shaped object.

Further, according to this embodiment, the material of the three-dimensional shaped object 100 to be manufactured is mainly the core material 5 made of a foamed resin, and hence the three-dimensional shaped object 100 has a small weight. Thus, the orderer can easily transport or install the three-dimensional shaped object 100, and less labor or cost is required for those kinds of work.

Further, according to this embodiment, the wrapping sticker 3 having printed thereon the image data derived from the planar image (for example, the photograph) of the form of the object 1 to be shaped is used to apply a decoration to the surface of the main body 6, and hence a painting step which has been required in the related-art method is not required. Thus, the material cost for manufacturing the three-dimensional shaped object 100 is reduced, and no time for curing or drying the material is required. In addition, when the three-dimensional shaped object 100 is manufactured, situations which require specialized knowledge or sophisticated technology are reduced. Thus, a worker for manufacturing the three-dimensional shaped object 100 can manufacture the three-dimensional shaped object 100 easily and with a short work time. As a result, the price of the three-dimensional shaped object 100 can be decreased, and there is no great difference in quality of the finished three-dimensional shaped object depending on the worker.

Further, according to this embodiment, the main body 6 to be formed into a three-dimensional shape is shaped by carving the core material 5, and hence work which has hitherto been generally performed so as to shape the main body is not required. In the work which has hitherto been generally performed, for example, clay or the like is used to create an original mold, and casting of plaster or the like is performed to create a female mold. Then, a main agent, for example, an FRP is injected into the female mold. After the main agent is cured, the main agent is demolded so that the main body of the three-dimensional shaped object is shaped. Thus, the worker for manufacturing the three-dimensional shaped object 100 can manufacture the three-dimensional shaped object 100 more easily and with a shorter work time.

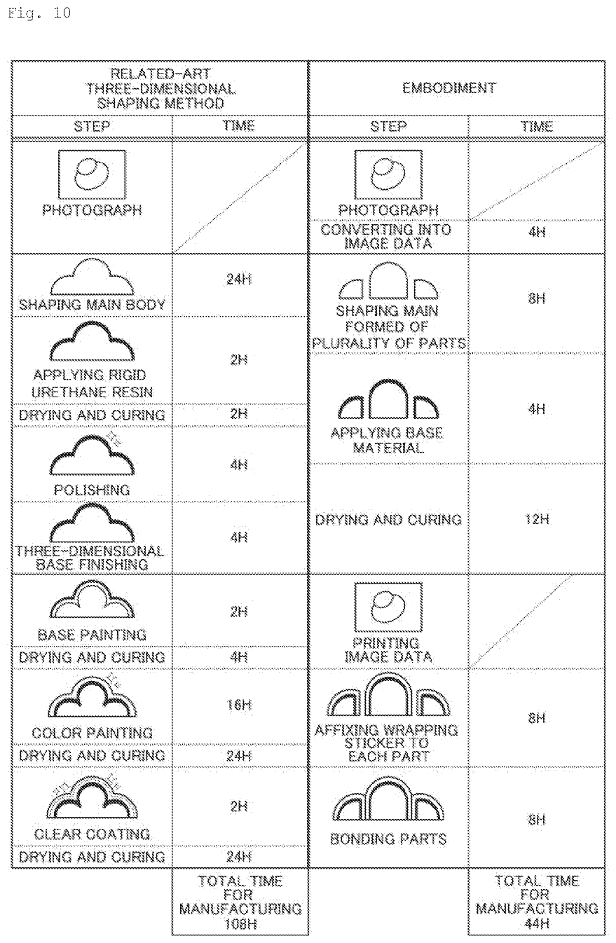

FIG. 10 is an explanatory table for showing comparison of a simplified process of steps and a work time in each step between the method of three-dimensionalizing a planar image according to this embodiment and a three-dimensional shaping method in which rigid urethane is sprayed, which has the shortest work time among the related-art three-dimensional shaping methods. The work time is just a rough standard. Further, a photograph is used as the planar image of the form of the object 1 to be shaped.

When the method of three-dimensionalizing a planar image according to this embodiment and the related-art three-dimensional shaping method are compared with each other, it is understood that, in this embodiment, first, the time required for shaping the main body into a three-dimensional shape can be greatly reduced. Further, no rigid urethane is sprayed, and hence expensive equipment for spraying the rigid urethane is not required. Further, it is understood that, in this embodiment, the surface of the main body is not applied with paint, and hence the time required for applying the paint and the time for drying and curing the material can be greatly reduced.

As described above, according to this embodiment, the “high price” and the “requirement of highly specialized knowledge and technology,” which have been problems in the related-art three-dimensional shaping method, can be solved, and anyone can manufacture the three-dimensional shaped object easily and at lost cost without causing a great difference in quality.

Moreover, according to this embodiment, in the three-dimensional shaped object 100 to be manufactured, the main body 6 is divided into the plurality of parts 60A to 60N, and the plurality of parts 60A to 60N are each processed so as to be formed into a predetermined shape in accordance with a corresponding region of the object 1 to be shaped. After that, the plurality of parts 60A to 60N are re-combined with each other so that the main body 6 is formed into a three-dimensional shape. Thus, the main body 6 can be shaped into a three-dimensional shape more easily, and hence the three-dimensional shaped object 100 can be manufactured with a shorter work time.

In addition, the object 1 to be shaped greatly changes in shape at boundaries between the regions 10A to 10N. However, when the main body 6 of the three-dimensional shaped object 100 is formed of the plurality of parts 60A to 60N, in the three-dimensional shaped object 100, this change in shape can be represented sharp. Thus, the three-dimensional, shaped object 100 can be manufactured with a higher reproducibility, and a realistic well-finished object can be obtained.

Moreover, according to this embodiment, the three-dimensional shaped object 100 to be manufactured is covered with the wrapping stickers 8A to 8N not only on the upper surfaces but also on the side surfaces of the respective parts 60A to 60N forming the main body 6. Accordingly, the aesthetic appearance of the three-dimensional shaped object 100 can be enhanced. In addition, the wrapping stickers 8A to 8N affixed to the surfaces of the respective parts 60A to 60N are partially sandwiched between corresponding parts 60A to 60N and other parts 60A to 60N adjacent thereto, and hence the wrapping stickers 8A to 8N are prevented from rolling up and peeling off from the parts 60A to 60N. Thus, the aesthetic appearance of the three-dimensional shaped object 100 can be prevented from being degraded.

Moreover, according to this embodiment, the three-dimensional shaped object 100 to be manufactured is formed so that the main body 6 being a three-dimensional object protrudes out from a plate material (in this embodiment, the core material 5) being a two-dimensional plane provided with a background. Thus, with the combination of the three-dimensional object and the plane, the main body 6 being the three-dimensional object is emphasized, and the main body 6 being the three-dimensional object can look more realistic.

Moreover, according to this embodiment, when the main body 6 obtained before the wrapping sticker 8 is affixed thereto is used as an original mold, a female mold can easily be manufactured.

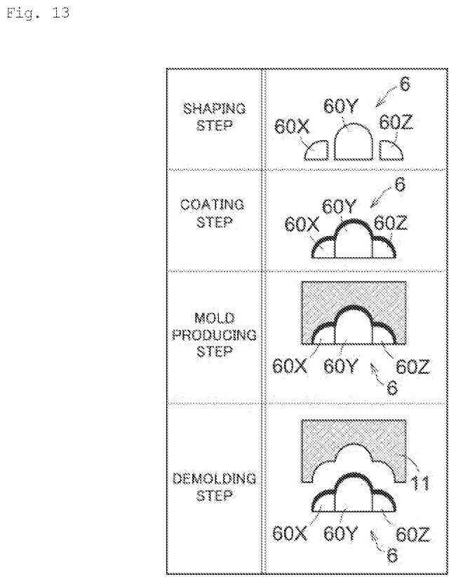

A method of manufacturing the female mold specifically includes, as illustrated in FIG. 13, a shaping step of carving a core material having a thickness so as to shape the main body 6 three-dimensionally representing a planar image of a form of an object to be shaped, a coating step of applying a base material to the surface of the main body 6, a mold creating step of manufacturing a female mold 11 through use of the main body 6 as an original mold, and a demolding step of removing the main body 6 from the female mold 11. In the shaping step, similarly to the step S1 described above, the object to be shaped is sectionalized into a plurality of regions in the planar image, and a plurality of parts 60X to 60Z are cut out from the core material along the contours of the respective regions of the object to be shaped. The plurality of parts 60X to 60Z are each processed so as to be formed into a predetermined shape in accordance with a corresponding region of the object to be shaped. Thus, the plurality of parts 60X to 60Z are combined with each other so that the main body 6 is shaped. The coating step can be performed similarly to the step S2 described above. In this manner, the female mold 11 to be used for manufacturing the three-dimensional shaped object obtained by three-dimensionalizing the planar image can easily be manufactured, and hence the three-dimensional shaped object can easily be manufactured.

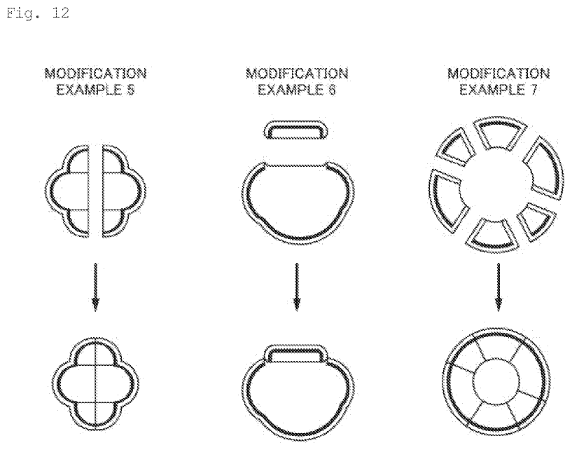

Further, a plastic plate having affixed, on its surface, one wrapping sticker 8 having printed thereon the entire image data of the object 1 to be shaped, or a plastic plate having directly printed, on its surface, the entire image data of the object 1 to be shaped is arranged on the main body 6, and the plastic plate is heat-pressed through use of the main body 6 as a mold while vacuuming is performed between the plastic plate and the main body 6. After that, the plastic plate is demolded and finished. In this manner, an internally-illuminated three-dimensional plate having affixed, on its surface, the wrapping sticker 8 having printed thereon the image data of the object 1 to be shaped or an internally-illuminated three-dimensional plate having printed thereon the image data of the object 1 to be shaped can easily be manufactured. A plurality of those three-dimensional plates may be stacked and integrated with each other, or a plurality of those three-dimensional plates may be arranged side by side in a circumferential direction and integrated with each other so that, as an object to be shaped illustrated in FIG. 12 to be referred to later, three-dimensionalization is performed over the entire circumference of 360°.

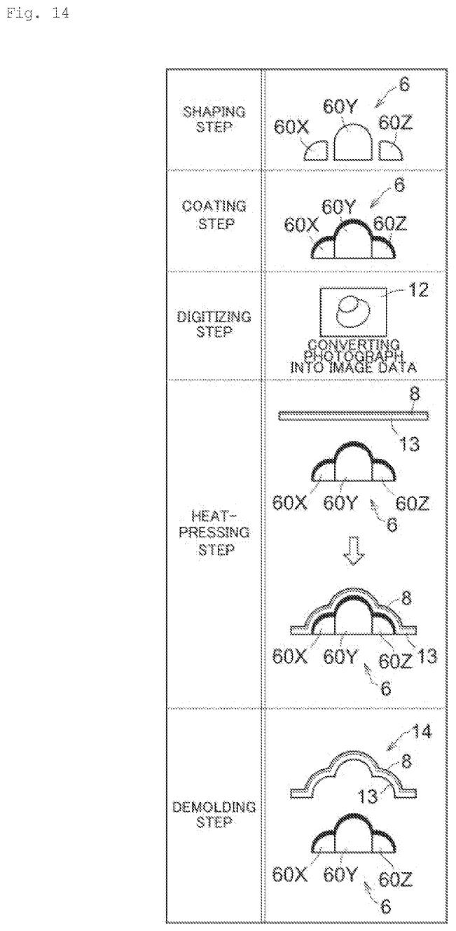

A method of manufacturing the three-dimensional plate specifically includes, as illustrated in FIG. 14, a shaping step of shaping the main body 6 three-dimensionally representing a planar image 12 of a form of an object to be shaped, a coating step of applying a base material to the surface of the main body 6, a digitizing step of creating image data of the object to be shaped based on the planar image 12, a heat-pressing step of arranging, on the main body 6, a plastic plate 13 having affixed, to its surface, the wrapping sticker 8 having printed thereon the image data of the object to be shaped, or a plastic plate (not shown) having directly printed, on its surface, the image data of the object to be shaped, and heat-pressing the surface of the plastic plate 13 while performing vacuuming between the plastic plate 13 and the main body 6, and a demolding step of removing the main body 6 from the plastic plate 13. In the shaping step, for example, similarly to the step S1 described above, the object to be shaped is sectionalized into a plurality of regions in the planar image 12, and the plurality of parts 60X to 60Z are cut out from the core material along the contours of the respective regions of the object to be shaped. The plurality of parts 60X to 60Z are each processed so as to be formed into a predetermined shape in accordance with a corresponding region of the object to be shaped. Thus, the plurality of parts 60X to 60Z are combined with each other so that the main body 6 is shaped. In this manner, when the plastic plate 13 is heat-pressed with respect to the main body 6 while vacuuming is performed, air is removed from gaps between the parts 60X to 60Z of the main body 6, and hence air can be effectively discharged. The coating step, the digitizing step, and the step of creating the wrapping sticker 8 can be performed similarly to the steps S2 to S4 described above. An internally-illuminated three-dimensional plate 14 can be obtained when the plastic plate 13 has light transmittance, but the plastic plate 13 may have no light transmittance. In FIG. 14, the plastic plate 13 with the wrapping sticker 8 is heat-pressed with respect to the main body 6, and then the main body 6 is removed from the plastic plate 13 so that the three-dimensional plate 14 is manufactured. However, the present invention is not limited thereto, and the three-dimensional plate can also be manufactured as follows. An FRP may be applied or blown to the outer surface of the main body 6 and then cured so that a plate base portion made of an FRP is formed on the outer surface of the main body 6. After that, the main body 6 may be removed from the plate base portion, and the wrapping sticker 8 having printed thereon the image data of the object to be shaped may be affixed to the surface of the plate base portion.

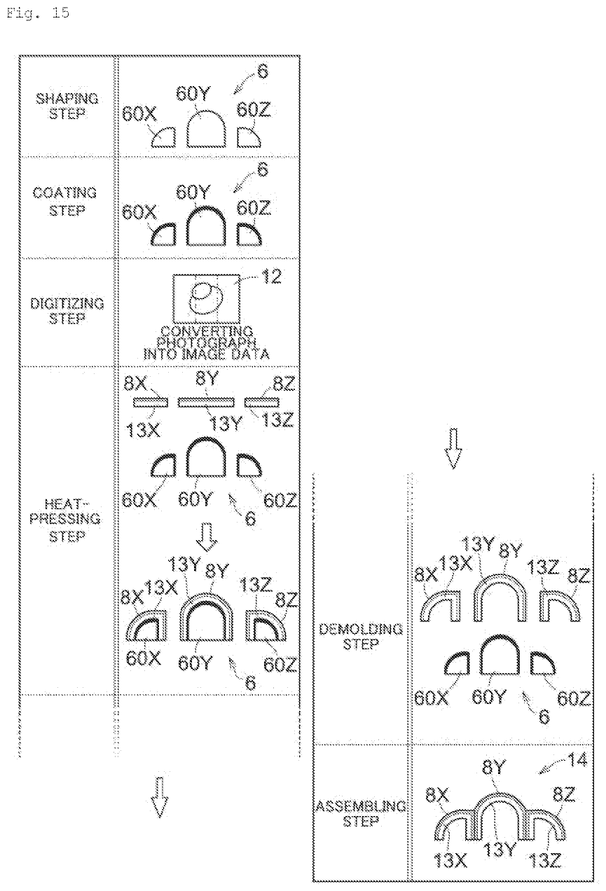

Further, the three-dimensional plate 14 can also be manufactured by the following method. The method specifically includes, as illustrated in FIG. 15: a shaping step of shaping the main body 6 three-dimensionally representing the planar image 12 of the form of the object to be shaped, the shaping step including sectionalizing the object to be shaped into a plurality of regions in the planar image 12, dividing the main body 6 into the plurality of parts 60X to 60Z so as to correspond to the plurality of regions of the object to be shaped, and processing each of the plurality of parts 60X to 60Z so that each part is formed into a predetermined shape in accordance with a corresponding region of the object to be shaped; a coating step of applying a base material to the surface of each of the parts 60X to 60Z; a digitizing step of creating the image data of the object to be shaped based on the planar image 12, the digitizing step including creating the image data for each region of the object to be shaped; a heat-pressing step of arranging, on the plurality of parts 60X to 60Z, a plurality of plastic plates 13X to 13Z having individually affixed, to their surfaces, a plurality of wrapping stickers 8X to 8Z having printed thereon the image data pieces of the respective regions of the object to be shaped, or a plurality of plastic plates (not shown) having individually and directly printed, on their surfaces, the image data pieces of the respective regions of the object to be shaped, and heat-pressing the surface of each of the plastic plates 13X to 13Z while performing vacuuming between the corresponding plastic plate and the corresponding part; a demolding step of removing the plurality of parts 60X to 60Z from the plurality of plastic plates 13X to 13Z; and an assembling step of combining and integrating the plurality of plastic plates 13X to 13Z with each other. In the shaping step, for example, similarly to the step S1 described above, the object to be shaped is sectionalized into a plurality of regions in the planar image 12, and the plurality of parts 60X to 60Z are cut out from the core material along the contours of the respective regions of the object to be shaped. The plurality of parts 60X to 60Z are each processed so as to be formed into a predetermined shape in accordance with a corresponding region of the object to be shaped. Thus, the main body 6 can be shaped. The plurality of plastic plates 13X to 13Z may be mainly formed of main body parts for covering the surfaces of the corresponding parts 60X to 60Z (surfaces to be exposed when the parts 60X to 60Z are combined with each other). However, as illustrated in FIG. 15, it is preferred that the plurality of plastic plates 13X to 13Z further include margin parts for covering at least parts of the side surfaces of the corresponding parts 60X to 60Z (surfaces not to be exposed but to be brought into contact with each other when the parts 60X to 60Z are combined with each other) because, when the margin parts are affixed to each other so that the parts 60X to 60Z are combined with each other, the parts 60X to 60Z can be satisfactorily integrated with each other. The coating step, the digitizing step, and the step of creating the wrapping sticker 8 can be performed similarly to the steps S2 to S4 described above. In FIG. 15, the plastic plates 13X to 13Z with the wrapping stickers 8X to 8Z are heat-pressed with respect to the parts 60X to 60Z of the main body 6, and then the parts 60X to 60Z are removed from the plastic plates 13X to 13Z so that the three-dimensional plate 14 is manufactured. However, the present invention is not limited thereto, and the three-dimensional plate can also be manufactured as follows. An FRP may be applied or blown to the outer surface of each of the parts 60X to 60Z of the main body 6 and then cured so that a plate base portion made of an FRP is formed on the outer surface of each of the parts 60X to 60Z of the main body 6. After that, each of the parts 60X to 60Z of the main body 6 may be removed from each plate base portion. Then, the wrapping stickers 8X to 8Z having printed thereon the image data pieces of the respective regions of the object to be shaped may be affixed to the surfaces of the respective plate base portions, and the plate base portions may be integrated with each other.

In the above, the embodiment of the present invention has been described, but the present invention is not limited to the above-mentioned embodiment, and various changes are possible within the range not departing from the object of the present invention.

For example, in the above-mentioned embodiment, each of the wrapping stickers 8A to 8N is not always required to cover the entire side surface of the corresponding one of the parts 60A to 60N, and is only required to cover a region viewable from the outside in the side surface of the corresponding one of the parts 60A to 60N.

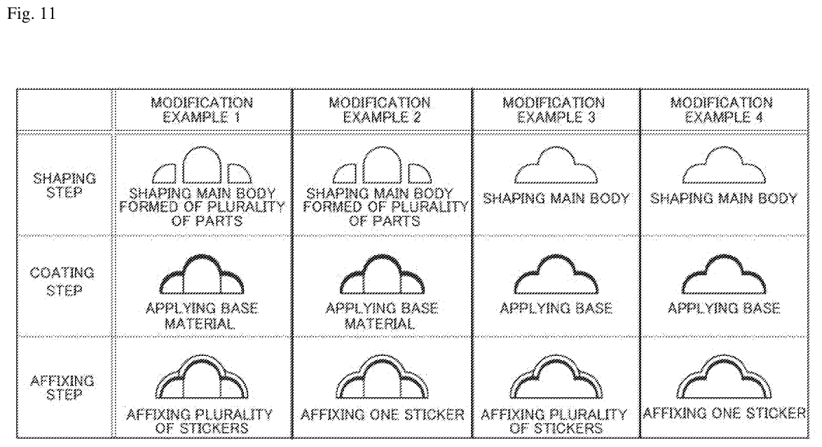

Further, in the above-mentioned embodiment, the plurality of wrapping stickers 8A to 8N having printed thereon the image data pieces of the respective regions of the object 1 to be shaped are individually affixed to the surfaces of corresponding parts among the plurality of parts 60A to 60N of the main body 6, and then the plurality of parts 60A to 60N are bonded to each other so that the main body 6 is formed. However, the present invention is not limited thereto. As shown in Modification Example 1 of FIG. 11, after the plurality of parts 60A to 60N are bonded to each other so that the main body 6 is formed, the plurality of wrapping stickers 8A to 8N may be individually affixed to the surfaces of the corresponding parts among the plurality of parts 60A to 60N forming the main body 6. In Modification Example 1, the plurality of wrapping stickers 8A to 8N may overlap each other at edge parts, or may be pushed in at boundaries between adjacent parts of the main body 6. As another example, as shown in Modification Example 2 of FIG. 11, after the plurality of parts 60A to 60N are combined with each other so that the main body 6 is formed, one wrapping sticker 8 having printed thereon the entire image data of the object 1 to be shaped may be collectively affixed to the surfaces of the plurality of parts 60A to 60N forming the main body 6. In this case, it is preferred that the affixing be performed while sucking air between the main body 6 and the wrapping sticker 8. The air is effectively removed from the gaps between the parts 60A to 60N because the main body 6 is divided into the plurality of parts 60A to 60N. Thus, the wrapping sticker 8 can be satisfactorily brought into close contact with the main body 6. In Modification Examples 1 and 2, in the coating step S2, the surfaces of the respective parts 60A to 60N forming the main body 6 are not required to be individually coated with the base material, and may be collectively coated with the base material as illustrated in FIG. 11.

Further, in the above-mentioned embodiment, the main body 6 is divided into the plurality of parts 60A to 60N, but, for example, when the object 1 to be shaped has a shape with less irregularities, as shown in Modification Examples 3 and 4 of FIG. 11, the main body 6 may be shaped into a three-dimensional shape without dividing the main body 6 into the plurality of parts 60A to 60N. In this case, as shown in Modification Example 4 of FIG. 11, one wrapping sticker 6 having printed thereon the entire image data of the object 1 to be shaped may be affixed to the surface of the main body 6, or as shown in Modification Example 3 of FIG. 11, the plurality of wrapping stickers 8A to 8N having printed thereon the image data pieces of the respective regions of the object 1 to be shaped may be individually affixed to the surfaces of the corresponding regions of the main body 6. In Modification Example 3, the plurality of wrapping stickers 8A to 8N may overlap each other at edge parts, or may be pushed in at boundaries between adjacent regions of the main body 6. In Modification Example 4, it is preferred that the affixing be performed while sucking air between the main body 6 and the wrapping sticker 8. When one or a plurality of air suction holes are formed in the main body 6, air is effectively removed through the hole(s). Thus, the wrapping sticker 8 can be satisfactorily brought into close contact with the main body 6. In Modification Examples 3 and 4, in the shaping step S1, the shaping into a predetermined shape is performed by cutting out the main body 6 from the core material 5. Further, in the background creating step S6, the core material S from which the main body 6 is cut out is processed so as to be thinner than the main body 6, and the surface of the core material 5 is provided with the background. In the integrating step S7, the main body 6 obtained after the affixing step S5 is fitted to the core material 5 obtained after the background creating step S6 so as to be integrated with the core material 5.

Further, in the above-mentioned embodiment, the main body 6 being the three-dimensional object is integrated with the core material 5 being the two-dimensional plane, but the two-dimensional plane to be integrated with the main body 6 is not always required to be the core material 5 from which the main body 6 (plurality of parts 60A to 60N) is cut out, and other plate materials may be used. In this embodiment, in the background creating step S6, the background is provided around a region in which the main body 6 is to be positioned in the surface of the plate material, and in the integrating step S7, the main body 6 obtained after the affixing step S5 is mounted on the surface of the plate material obtained after the background creating step S6 so that the main body 6 is positioned in the region, to thereby integrate the main body 6 with the plate material.

Further, in the above-mentioned embodiment, the main body 6 being the three-dimensional object is integrated with the core material 5 being the two-dimensional plane, but the main body 6 is not always required to be integrated with a two-dimensional plane. For example, as shown in Modification Examples 5 to 7 of FIG. 12, a plurality of main bodies may be shaped based on a plurality of planar images relating to the form of the object to be shaped. After that, the plurality of main bodies whose surfaces have been subjected to coating of the base material and affixing of the wrapping sticker may be overlapped with each other so as to be integrated with each other, or the plurality of main bodies may be arranged side by side in the circumferential direction so as to be integrated with each other. Thus, the three-dimensional shaped object obtained by three-dimensionalizing the object to be shaped over the entire circumference of 360° may be manufactured.

As another example, although not shown, a main body may be shaped by three-dimensionalizing the object to be shaped over the entire circumference of 360° based on the plurality of planar images relating to the form of the object to be shaped. After that, the surface of the main body may be coated with the base material, and further one wrapping sticker having printed thereon the entire image data of the object to be shaped may be affixed to the surface of the main body, or the plurality of wrapping stickers having printed thereon the image data pieces of the respective regions of the object to be shaped may be individually affixed to the surfaces of the corresponding regions of the main body. Thus, the three-dimensional shaped object 100 obtained by three-dimensionalizing the object to be shaped over the entire circumference of 360°0 may be manufactured. When the plurality of wrapping stickers are affixed, the plurality of wrapping stickers may overlap each other at edge parts, or may be pushed in at boundaries between adjacent regions of the main body.

Further, in the above-mentioned embodiment, when the three-dimensional shaped object 100 or the three-dimensional plate 14 is manufactured, the main body 6 is shaped by carving the core material 5 made of, for example, foam of a synthetic resin, but the three-dimensional shaping method for the main body 6 is not limited thereto. For example, the main body 6 may be made of clay, and the clay may be, for example, manually molded or molding may be performed by applying the clay to the inner surface of the mold so that the main body 6 is shaped. As another example, the main body 6 may be made of a plastic or a fiber reinforced plastic such as an FRP, and the molding may be performed by pouring a resin into the mold or applying or blowing the resin to the inner surface of the mold so that the main body 6 is shaped. As another example, the main body 6 may be shaped through use of an additive manufacturing method using a 3D printer or the like or other three-dimensional shaping methods.

Also in this embodiment, the main body 6 may be divided into the plurality of parts 60A to 60N, and the plurality of parts 60A to 60N may be each processed so as to be formed into a predetermined shape. Thus, the plurality of parts 60A to 60N may be combined with each other so that the main body 6 is shaped.

Specifically, in the shaping step, the object to be shaped is sectionalized into ad plurality of regions in the planar image, and the main body 6 is divided into a plurality of parts so as to correspond to the plurality of regions of the object to be shaped. The plurality of parts are each processed so as to be formed into a predetermined shape in accordance with a corresponding region of the object to be shaped. Thus, the plurality of parts are combined with each other so that the main body is shaped. Further, regarding the wrapping sticker, similarly to the above-mentioned embodiment, in the digitizing step, the image data is created for each region of the object to be shaped, and in the sticker creating step, a plurality of wrapping stickers having printed thereon the image data pieces of the respective regions of the object to be shaped are created. Then, in the affixing step, the corresponding wrapping sticker among the plurality of wrapping stickers is affixed to the surface of each of the plurality of parts. In this manner, even without shaping the main body through carving of the core material, the three-dimensional shaped object can be manufactured.

Further, similarly to Modification Example 2 of FIG. 11, one wrapping sticker having printed thereon the entire image data of the object to be shaped may be collectively affixed to the surfaces of the plurality of parts forming the main body. Specifically, in the shaping step, the object to be shaped is sectionalized into a plurality of regions in the planar image, and the main body is divided into a plurality of parts so as to correspond to the plurality of regions of the object to be shaped. The plurality of parts are each processed so as to be formed into a predetermined shape in accordance with a corresponding region of the object to be shaped. Thus, the plurality of parts are combined with each other so that the main body is shaped. Then, in the affixing step, one wrapping sticker is collectively affixed to the surfaces of the plurality of parts. In this manner, even without shaping the main body through carving of the core material, the three-dimensional shaped object can be manufactured.

Further, similarly to Modification Example 3 of FIG. 11, the main body may be shaped into a three-dimensional shape without dividing the main body into the plurality of parts, and the plurality of wrapping stickers having printed thereon the image data pieces of the respective regions of the object to be shaped may be individually affixed to the surfaces of the corresponding regions of the main body. Specifically, in the shaping step, the main body three-dimensionally representing the planar image of the form of the object to be shaped is shaped, and in the digitizing step, the image data is created for each region of the object to be shaped which is sectionalized into a plurality of regions in the planar image. In the sticker creating step, a plurality of wrapping stickers having printed thereon the image data pieces of the respective regions of the object to be shaped are created. Then, in the affixing step, the plurality of wrapping stickers are individually affixed to the surfaces of the corresponding regions of the main body. In this manner, even without shaping the main body through carving of the core material, the three-dimensional shaped object can be manufactured.

Also in those embodiments, the main body being the three-dimensional object may be integrated with a plate material being a two-dimensional plane. Specifically, in the background creating step, the background is provided around a region in which the main body is to be positioned in the surface of the plate material, and in the integrating step, the main body obtained after the affixing step is mounted on the surface of the plate material obtained after the background creating step so that the main body is positioned in the region, to thereby integrate the main body with the plate material.

Further, in the above-mentioned embodiment, regarding the object to be shaped, a main body three-dimensionally representing the object to be shaped by 180 degrees is shaped based on one planar image, but in the shaping step, a plurality of planar images showing the form of the object to be shaped from different angles may be used so that a train body three-dimensionally representing the object to be shaped by 360 degrees is shaped based on the plurality of planar images. In this case, in the digitizing step and the sticker creating step, a plurality of image data pieces of the object to be shaped are created based on the plurality of planar images, and a plurality of wrapping stickers having printed thereon the respective image data pieces are created. Then, in the affixing step, the plurality of wrapping stickers are individually affixed to the surfaces of the corresponding regions of the main body. Thus, the three-dimensional shaped object is manufactured. The plurality of wrapping stickers may overlap each other at edge parts, or may be pushed in at boundaries between adjacent regions of the main body.

### EXPLANATION OF REFERENCE NUMERALS

1 object to be shaped
10A to 10N region
2 background
3 planar image
5 core material
6 main body
60A to 60N part
7A to 7N image data piece
8A to 8N wrapping sticker

1. A method of three-dimensionalizing a planar image, the method comprising:
a shaping step of shaping a main body three-dimensionally representing a planar image of a form of an object to be shaped;
a digitizing step of creating image data of the object to be shaped based on the planar image;
a sticker creating step of creating a wrapping sticker having printed thereon the image data of the object to be shaped; and
an affixing step of affixing the wrapping sticker to a surface of the main body.

2. The method of three-dimensionalizing a planar image according to claim 1, wherein the main body is shaped by carving a core material having a thickness.

3. The method of three-dimensionalizing a planar image according to claim 2,
wherein the shaping step includes sectionalizing the object to be shaped into a plurality of regions in the planar image, cutting out a plurality of parts from the core material along contours of respective regions of the object to be shaped, and processing each of the plurality of parts so that each part is formed into a predetermined shape, to thereby combine the plurality of parts with each other so that the main body is shaped,
wherein the digitizing step includes creating the image data for each region of the object to be shaped,
wherein the sticker creating step includes creating a plurality of wrapping stickers having printed thereon image data pieces of the respective regions of the object to be shaped, and
wherein the affixing step includes affixing a corresponding wrapping sticker among the plurality of wrapping stickers to a surface of each of the plurality of parts.

4. The method of three-dimensionalizing a planar image according to claim 3, the method further comprising:
a background creating step of providing a surface of the core material with a background after the core material from which the plurality of parts are cut out is processed so as to be thinner than the plurality of parts; and
an integrating step of fitting the plurality of parts obtained after the affixing step to the core material obtained after the background creating step, to thereby integrate the plurality of parts with the core material.

5. The method of three-dimensionalizing a planar image according to claim 2,
wherein the shaping step includes cutting out the main body from the core material so as to shape the main body into a predetermined shape, and
wherein the method of three-dimensionalizing a planar image further comprises:
a background creating step of providing a surface of the core material with a background after the core material from which the main body is cut out is processed so as to be thinner than the main body; and
an integrating step of fitting the main body obtained after the affixing step to the core material obtained after the background creating step, to thereby integrate the main body with the core material.

6. The method of three-dimensionalizing a planar image according to claim 1,
wherein the shaping step includes sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape, to thereby combine the plurality of parts with each other so that the main body is shaped,
wherein the digitizing step includes creating the image data for each region of the object to be shaped,
wherein the sticker creating step includes creating a plurality of wrapping stickers having printed thereon image data pieces of respective regions of the object to be shaped, and
wherein the affixing step includes affixing a corresponding wrapping sticker among the plurality of wrapping stickers to a surface of each of the plurality of parts.

7. The method of three-dimensionalizing a planar image according to claim 1,
wherein the shaping step includes sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape, to thereby combine the plurality of parts with each other so that the main body is shaped, and
wherein the affixing step includes collectively affixing the wrapping sticker to surfaces of the plurality of parts.

8. The method of three-dimensionalizing a planar image according to claim 1,
wherein the digitizing step includes creating the image data for each region of the object to be shaped sectionalized into a plurality of regions in the planar image,
wherein the sticker creating step includes creating a plurality of wrapping stickers having printed thereon image data pieces of respective regions of the object to be shaped, and
wherein the affixing step includes individually affixing the plurality of wrapping stickers to surfaces of corresponding regions of the main body.

9. The method of three-dimensionalizing a planar image according to claim 3, wherein the image data of each region of the object to be shaped, which is created in the digitizing step, is formed by extending actual image data cut out from entire image data of the object to be shaped along a contour of the each region.

10. The method of three-dimensionalizing a planar image according to claim 9, wherein the image data of the each region of the object to be shaped includes the actual image data of the each region and additional image data added to at least a part around the actual image data.

11. The method of three-dimensionalizing a planar image according to claim 6, the method further comprising:
a background creating step of providing a background around a region in which the main body is to be positioned in a surface of a plate material; and
an integrating step of mounting the main body obtained after the affixing step on the surface of the plate material obtained after the background creating step so that the main body is positioned in the region, to thereby integrate the main body with the plate material.

12. A three-dimensional shaped object, comprising one or a plurality of wrapping stickers having printed thereon image data derived from a planar image of a form of an object to be shaped, the one or plurality of wrapping stickers being affixed to a surface of a main body three-dimensionally representing the planar image.

13. The three-dimensional shaped object according to claim 12,
wherein the plurality of wrapping stickers respectively have image data pieces relating to a plurality of regions of the object to be shaped in the planar image printed thereon,
wherein the main body is divided into a plurality of parts so as to correspond to the plurality of regions of the object to be shaped, and the plurality of parts are each processed so as to be formed into a predetermined shape, to thereby combine the plurality of parts with each other so that the main body is formed into a three-dimensional shape, and
wherein a corresponding wrapping sticker among the plurality of wrapping stickers is affixed to a surface of each of the plurality of parts.

14. The three-dimensional shaped object according to claim 13, wherein a part of the wrapping sticker affixed to the surface of corresponding one of the parts is sandwiched between the corresponding one of the parts and another part adjacent thereto.

15. The three-dimensional shaped object according to claim 12,
wherein the main body is divided into a plurality of parts so as to correspond to a plurality of regions of the object to be shaped in the planar image, and the plurality of parts are each processed so as to be formed into a predetermined shape, to thereby combine the plurality of parts with each other so that the main body is formed into a three-dimensional shape, and
wherein the one wrapping sticker is collectively affixed to surfaces of the plurality of parts.

16. The three-dimensional shaped object according to claim 12,
wherein the plurality of wrapping stickers respectively have image data pieces relating to a plurality of regions of the object to be shaped in the planar image printed thereon, and
wherein the plurality of wrapping stickers are individually affixed to surfaces of corresponding regions of the main body.

17. The three-dimensional shaped object according to claim 12, further comprising a plate material provided with a background around a region in which the main body is to be positioned in a surface,
wherein the main body is mounted on the surface of the plate material so that the main body is positioned in the region, to thereby integrate the main body with the plate material.

18. (canceled)

19. A method of manufacturing a three-dimensional plate, the method comprising:
a shaping step of shaping a main body three-dimensionally representing a planar image of a form of an object to be shaped, the shaping step including sectionalizing the object to be shaped into a plurality of regions in the planar image, dividing the main body into a plurality of parts so as to correspond to the plurality of regions of the object to be shaped, and processing each of the plurality of parts so that each part is formed into a predetermined shape;
a digitizing step of creating image data of the object to be shaped based on the planar image, the digitizing step including creating the image data for each region of the object to be shaped;
a step of heat-pressing, with respect to surfaces of the plurality of parts, a plurality of plastic plates having individually affixed, to surfaces thereof, a plurality of wrapping stickers having printed thereon image data pieces of respective regions of the object to be shaped, or a plurality of plastic plates having individually and directly printed, on surfaces thereof, the image data pieces of the respective regions of the object to be shaped, while performing vacuuming between the plastic plate corresponding to each part and the each part;
a step of removing the plurality of parts from the plurality of plastic plates; and
a step of combining and integrating the plurality of plastic plates with each other.

20. (canceled)
